(19) United States
(12) Patent Application Publication
(10) Pub. No.: US 2004/0216912 A1
(43) Pub. Date: Nov. 4, 2004

(54) High temperature liquidtight flexible metal conduit fitting

(75) Inventor: Robert H. Osborn JR., Collierville, TN (US)

Correspondence Address: HOFFMANN & BARON, LLP, 6900 JERICHO TURNPIKE, SYOSSET, NY, 11791, US

(73) Assignee: Thomas & Betts International, Inc.

(21) Appl. No.: 10/803,642

(22) Filed: Mar. 18, 2004

Related U.S. Application Data
(60) Provisional application No. 60/466,921, filed on May 1, 2003.

(51) Int. Cl. H02G 15/30

(52) U.S. Cl. 174/73.1

(57) ABSTRACT

An electrical fitting terminates a jacketed flexible metallic conduit. The fitting includes conductive metal components, such as a body, gland nut and ground cone. The fitting also includes non-metallic insulative components such as a sealing ring and an insulated throat. These components are formed of a high-temperature resistant material so that the fitting may be rated for high-temperature applications.

### CROSS-REFERENCE TO RELATED APPLICATIONS

This application claims priority to U.S. Provisional Application No. 60/466,921, filed May 1, 2003.

### FIELD OF THE INVENTION

The present invention relates generally to a fitting for terminating a flexible metallic conduit. More particularly, the present invention relates to a liquidtight fitting for terminating flexible metallic conduit, having high temperature resistant characteristics.

### BACKGROUND OF THE INVENTION

It has long been known to use fittings to terminate electrical conduit, especially electrical conduit of the flexible metallic variety. Such conduit typically includes the plurality of insulated electrical conductors surrounded by a flexible metallic armor. An insulated jacket is positioned over the metallic armor. Fittings of the liquidtight variety are used to attach such conduit to a panel structure such as one for an electrical enclosure. It is desirable that the fittings engage the conduit in a liquidtight relationship as defined by the National Electrical Code (NEC). Also, the fitting itself should be placed in ground continuity with the metallic armor of the conduit.

Various fittings of this type are well known in the art. U.S. Pat. No. 3,448,430 issued Jun. 3, 1969, entitled Ground Connector, shows a typical fitting used to terminate flexible metallic conduit. Similarly, U.S. Pat. No. 3,603,912 issued Sep. 7, 1971 entitled Raceway Terminator, shows such a fitting attached through the knockout of a wall of an electrical enclosure. Each of these patents are incorporated by reference herein, in their entirty for all purposes. Additionally, U.S. Pat. No. 5,929,383, issued Jul. 27, 1999 entitled Rotationally Unrestrained Grounding Coupling for External Grounding of Fittings, shows a liquidtight fitting terminating a conduit to a panel of an enclosure. The fitting of the '383 patent allows external grounding of the fitting. This patent is also incorporated by reference herein, in its entirety for all purposes.

Each of the above referenced fittings effect liquidtight termination of the conduit by employing a sealing ring interposed between the body of the fitting and a gland nut used to tighten the fitting to the conduit. The sealing ring is typically formed of a resilient plastic material which compresses upon tightening of the gland nut to the body to effect a seal thereat about the jacket of the conduit. The sealing ring is typically formed of a material which is sufficiently pliable so as to effect a liquidtight seal with the cable upon attachment of the gland nut to the body.

Recently fittings have been developed which are designed to work in high temperature environments. Fittings in the prior art are typically rated for 105° C. or less. New demands on such fittings now require that fittings be rated for up to 150° C.

While the basic construction of the existing fitting would satisfy such requirement the material which forms the sealing ring can not withstand such high temperatures. Moreover, many of the fittings of the type described above also include an insulated throat for protecting the insulating conductor which extend therethrough. This insulated throat is also formed of a plastic material. It has been found that the plastic material used for the insulated throat also is not able to withstand such high temperatures. It is therefore desirable to provide a liquidtight fitting for permeating flexible metallic conduit which is rated for high temperature applications.

### SUMMARY OF THE INVENTION

An electrical fitting is provided for terminating a flexible metallic conduit. The fitting includes an elongate connector body having a conduit receiving end and a wire egressing end. A gland nut is attachable to the conduit receiving end of the body. The sealing ring is interposed between the gland nut and the body to establish a seal thereat upon attachment of the glad nut to the conduit. The sealing ring is formed of high temperature resistant material.

The connector body and the gland nut are formed of conductive metal for establishing ground continuity with the metallic conduit.

### BRIEF DESCRIPTION OF THE DRAWINGS

FIG. 1 is a cross-sectional view of the high temperature liquidtight flexible metal conduit fitting of the present invention used for straight through applications.

FIG. 2 is a cross-sectional view of a fitting similar to that of FIG. 1, used for 45° applications.

FIG. 3 is a cross-sectional view of a fitting similar to FIG. 1 used in 9° applications.

### DETAILED DESCRIPTION OF THE PREFERRED EMBODIMENTS

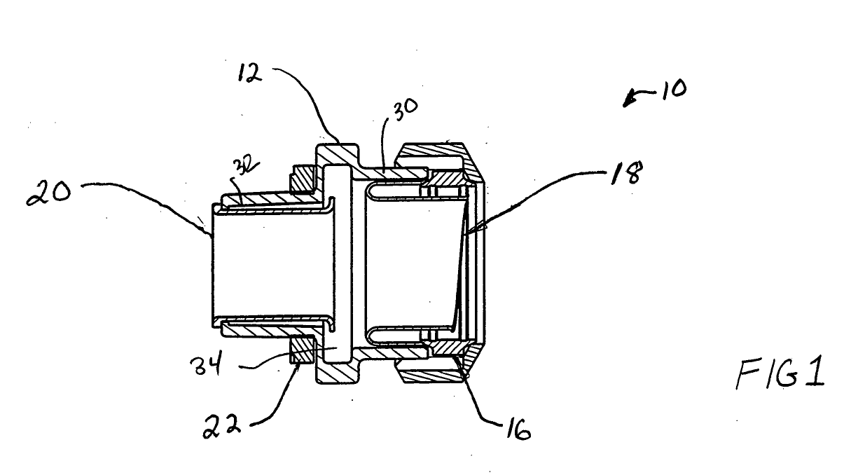

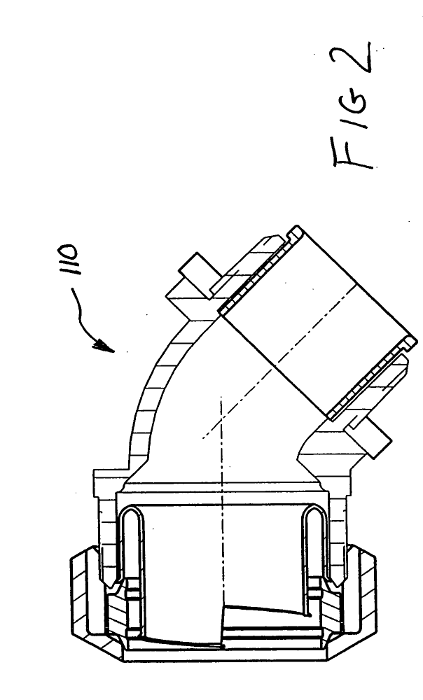

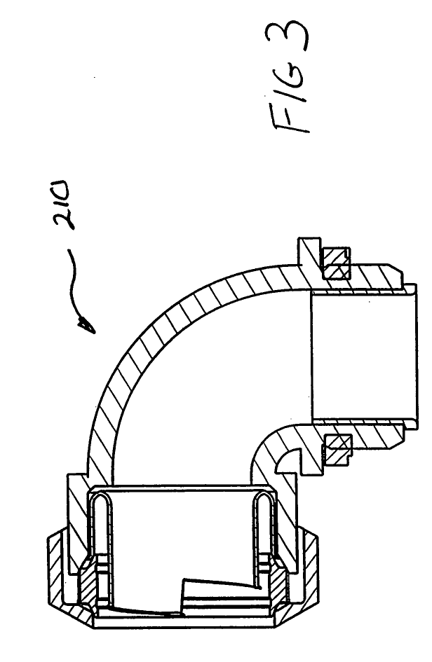

The present invention provides a high-temperature liquidtight flexible conduit fitting useful for terminating a jacketed metal-clad flexible conduit (not shown) having a plurality of insulated conductors extending therethrough. Further, the invention will be described with respect to the embodiment of FIG. 1 showing a fitting for straight through applications. It, however, may be appreciated that the present invention may be practiced with respect to 45° and 90° fittings 110, 210 shown in FIGS. 2 and 3, respectively.

Fitting 10 of the present invention is a multipart component including body 12, gland nut 14, a sealing ring 16, a ground cone 18, an insulated throat 20, and a locking nut 22. As will be described in further detail hereinbelow, body 12, gland nut 14, ground cone 18, and locking nut 22 may be formed of conductive materials, preferably zinc plated steel. As will also be described hereinbelow, the sealing ring 16 and the insulated throat 20 are formed of high-temperature resistant insulative plastic materials.

Body 12 of fitting 10, is an elongate member having a conduit receiving end 30, a conductor egressing end 32, and a central bore 34 extending therethrough. The central bore 34 of body 12 accommodates the flexible conduit therethrough so that the insulated conductor extends through the conductor egressing end 32. In order to insulate the conductors from the metallic body 12 and provide protection for the insulation of the conductors, a cylindrical insulated throat 20 is interposed into the conductor egressing end 32 of body 12.

Gland nut 14 is attachable to the conduit receiving end of body 12. The gland nut 14 may be internally screw threaded to threadingly attach to the external screw threads of the conduit receiving end 30 of body 12.

Interposed within the conduit receiving end 30 of body 12 is ground cone 18 which, upon termination of the conduit to the fitting 10 establishes ground connection between the metal jacket of the conduit and the metallic body 12 of fitting 10. A locknut 22 is threadingly attached to the conductor egressing end 32 of body 12 so that the body of the terminated conduit can be attached to a panel of an electrical enclosure (not shown). The locknut 22 is also formed of metallic material so that it can establish ground connection between the panel and body 12. The present invention also contemplates attachment of fitting 10 to an enclosure by screw threaded attachment of the externally threaded conductor egressing end 32 of body 12 to a threaded aperture. In this situation the locknut 22 need not be used.

Interposed between gland nut 14 and the conduit receiving end 30 of body 12 is a sealing ring 16. Sealing ring 16 is formed of suitably resilient material so that upon screw attachment of the gland nut 14 to the body 12, the sealing ring will effect a seal therebetween with the jacket of the conduit inserted therein. Sealing ring 16 is formed of a resiliently compressible material so as to effectuate such a seal.

The fitting 10 of the present invention is particularly designed for high-temperature application. In accordance therewith, the material forming sealing ring 16 is formed of high-temperature resistant resilient plastic. More specifically, by way of a preferred material, the present invention provides a sealing ring formed of a nylon 4/6 material. This material is sold under the trade name Stanyl TW341 available from DSM Engineering Plastics. The nylon 4/6 material of the present invention has a higher temperature resistance than the material previously used for sealing ring 16 which is commonly nylon 6/6 sold under the trade name Zytel 101. Use of nylon 4/6 material for sealing ring 16 allows the fitting of the present invention to be rated for applications of 150° C.

In addition, in order for the fitting 10 to achieve such a rating, the insulated throat 20 of the present invention may also be formed of the same high-temperature resistant material. Thus, the entire connector may be used in an environment where temperatures reach 150° C. and still maintain adequate liquidtight electrical and mechanical connection.

Various changes to the foregoing described and shown structures will now be evident to those skilled in the art. Accordingly, the particularly disclosed scope of the invention is set forth in the following claims.

What is claimed is:

1. An electrical fitting for terminating a flexible jacketed metal conduit comprising:
an elongated connector body having a conduit receiving end and a conductor egressing end;
a gland nut attachable to said conduit receiving end of said body; and
a sealing ring interposed between said gland nut and said body for establishing a seal thereat upon said attachment of said gland nut to said conduit, said sealing ring being formed of high-temperature resilient material.

2. An electrical fitting of claim 2 wherein said material comprises nylon 4/6.

3. An electrical fitting of claim 1 further including an insulated throat supported within said conductor egressing end of said body, said throat being formed of high-temperature resistant material.

4. An electrical fitting of claim 1 wherein said body and gland nut are formed of conductive metal.

5. An electrical fitting of claim 4 further including a ground cone supported by said body for engagement with said metal conduit for establishing electrical ground connection between said body and said metal conduit.

6. An electrical fitting of claim 5 wherein said conductor egressing end is externally screw threaded for insertion into an opening in a panel of an electrical enclosure.

7. An electrical fitting of claim 6 further including an internally threaded lock nut for screw threaded attachment to said conduit engaging end for securing said body to said panel.

8. An electrical fitting of claim 1 wherein said conduit engaging end is linearly aligned with said conductive receiving end.

9. An electrical fitting of claim 1 wherein said conductor egressing end is aligned at an angle with respect to conductor receiving end.

10. An electrical fitting of claim 9 wherein said angle is 45°.

11. An electrical fitting of claim 9 wherein said angle is 90°.
